(19) United States
(12) Patent Application Publication
(10) Pub. No.: US 2024/0142793 A1
(43) Pub. Date: May 2, 2024

(54) VIEW ENHANCING EYEWEAR

(71) Applicant: Rashad Wade, Baltimore, MD (US)

(72) Inventor: Rashad Wade, Baltimore, MD (US)

(21) Appl. No.: 17/979,624

(22) Filed: Nov. 2, 2022

(51) Int. Cl. G02B 30/22

(52) U.S. Cl. CPC G02B 30/22

(57) ABSTRACT

A view enhancing eyewear, including a frame to be worn on at least a portion of a face of a user, a plurality of lenses removably connected to at least a portion of the frame, at least one sensor disposed within at least a portion of the frame to detect light received thereon and send data therefrom, and a control unit disposed within at least a portion of the frame to convert at least one of at least one image and at least one video viewed on the plurality of lenses from two-dimensional to three-dimensional in response to determining the data from the at least one sensor is from at least one of a television, a movie screen, a movie theater, a play, a concert, and a video.

### BACKGROUND

### 1. Field

The present general inventive concept relates generally to eyewear, and particularly, to a view enhancing eyewear.

### 2. Description of the Related Art

There are many types of electronic media for entertainment, such as television, movies, and/or videos. In most cases, these types of electronic media are viewed in a two-dimensional view. In other words, an image provided on the television and/or the movies is a flat image.

Moreover, while standing and/or sitting far away at a concert, a show, or a movie theater, people may often struggle to clearly see what is being shown ahead of them.

Therefore, there is a need for a view enhancing eyewear that converts the two-dimensional image into a three-dimensional image.

### SUMMARY

The present general inventive concept provides a view enhancing eyewear.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a view enhancing eyewear, including a frame to be worn on at least a portion of a face of a user, a plurality of lenses removably connected to at least a portion of the frame, at least one sensor disposed within at least a portion of the frame to detect light received thereon and send data therefrom, and a control unit disposed within at least a portion of the frame to convert at least one of at least one image and at least one video viewed on the plurality of lenses from two-dimensional to three-dimensional in response to determining the data from the at least one sensor is from at least one of a television, a movie screen, a movie theater, a play, a concert, and a video.

Each of the plurality of lenses may correct vision of the user.

The control unit may abstain from converting at least one of the at least one image and the at least one video viewed on the plurality of lenses from two-dimensional to three-dimensional in response to determining the data from the at least one sensor is an object other than at least one of the television, the movie screen, the movie theater, the play, the concert, and the video.

The control unit may determine the data from the at least one sensor is from at least one of the television, the movie screen, the movie theater, the play, the concert, and the video based on light received therefrom.

The view enhancing eyewear may further include a plurality of lights disposed on at least a portion of the frame to emit a beam of light to illuminate a surrounding area in response to being turned on.

The control unit may turn on the plurality of lights in response to the at least one sensor detecting at least one of dark and low light conditions and uses light from the plurality of lights to convert at least one of the at least one image and the at least one video viewed on the plurality of lenses from two-dimensional to three-dimensional.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric view of a view enhancing eyewear, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

View Enhancing Eyewear 100
Frame 110
Rims 111
Temples 112
Bridge 113
Lenses 120
Lights 130
Sensor 140
Control Unit 150
Power Source 160

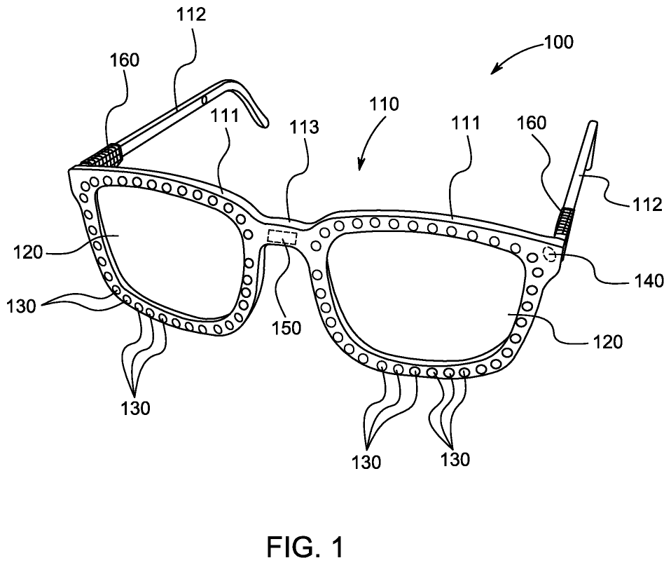

FIG. 1 illustrates an isometric view of a view enhancing eyewear 100, according to an exemplary embodiment of the present general inventive concept.

The view enhancing eyewear 100 may be constructed from at least one of metal, plastic, wood, glass, and rubber, etc., but is not limited thereto.

The view enhancing eyewear 100 may include a frame 110, a plurality of lenses 120, a plurality of lights 130, at least one sensor 140, a control unit 150, and a power source 160, but is not limited thereto.

Referring to FIG. 1, the frame 110 is illustrated to be a pair of eyeglasses. However, the frame 110 may be any type of eyewear, such as sunglasses, contact lenses, monocles, goggles, etc., but is not limited thereto

The frame 110 may include a plurality of rims 111, a plurality of temples 112, and a bridge 113, but is not limited thereto.

The plurality of rims 111 may have a predetermined size and/or a predetermined shape based on a preference of a user and/or a manufacturer.

Each of the plurality of temples 112 may be movably (i.e., pivotally, rotatably, hingedly) disposed on at least a portion of an edge of at least one of the plurality of rims 111. Moreover, the plurality of temples 112 may move from retracted (i.e., folded) against the plurality of rims 111 in a first position to at least partially extended away from the plurality of rims 111 in a second position. Conversely, the plurality of temples 112 may move from extended away from the plurality of rims 111 in the second position to retracted against the plurality of rims 111 in the first position. As such, the plurality of rims 111 and/or the plurality of temples 112 may facilitate storage while the plurality of temples 112 are in the first position, and the plurality of rims 111 and/or the plurality of temples 112 may be worn on a face (e.g., over eyes and/or ears) of the user while the plurality of temples 112 are in the second position.

The bridge 113 may be disposed between each of the plurality of rims 111. For example, the bridge 113 may connect a first of the plurality of rims 111 to a second of the plurality of rims 111. Also, the bridge 113 may be worn on at least a portion of a nose of the user.

Each of the plurality of lenses 120 may include a plasma screen, an LCD screen, a light emitting diode (LED) screen, an organic LED (OLED) screen, a computer monitor, a hologram output unit, a sound outputting unit, or any other type of device that visually or aurally displays data.

The plurality of lenses 120 may be removably connected to each of the plurality of rims 111. The plurality of lenses 120 may be constructed to improve and/or correct vision as required by the user (e.g., prescription lenses, reading glasses, etc.) due to impaired vision, such as near-sightedness and/or far-sightedness.

Each of the plurality of lights 130 may include a light-emitting diode (LED) and an incandescent bulb, but is not limited thereto.

The plurality of lights 130 may be disposed on at least a portion of the plurality of rims 111 and around a perimeter of each of the plurality of lenses 120 within the plurality of rims 111. Each of the plurality of lights 130 may emit a beam of light to illuminate a surrounding area in response to being turned on.

The at least one sensor 140 may include a motion sensor, a light sensor, and/or any combination thereof, but is not limited thereto.

The at least one sensor 140 may be disposed within at least a portion of the plurality of rims 111. The at least one sensor 140 may detect movement and/or light that has been received based on a television, a movie screen, a movie theater, a play, a concert, and/or a video from an electronic device (e.g., a mobile device, a cell phone, a tablet computer, a laptop computer, a desktop computer, etc.). The at least one sensor 140 may send data therefrom.

The control unit 150 may include a processing unit, a communication unit, and a storage unit, but is not limited thereto.

The processing unit of the control unit 150 (or central processing unit, CPU) may include electronic circuitry to carry out instructions of a computer program by performing basic arithmetic, logical, control and input/output (I/O) operations specified by the instructions. The processing unit of the control unit 150 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 150 may also include a microprocessor and a microcontroller.

The communication unit of the control unit 150 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit of the control unit 150 may include a random access memory (RAM), a read-only memory (ROM), a hard disk, a flash drive, a database connected to the Internet, cloud-based storage, Internet-based storage, or any other type of storage unit.

The control unit 150 may be disposed within at least a portion of the plurality of rims 111, the plurality of temples 112, and/or the bridge 113. The communication unit of the control unit 150 may download a software application from the Internet and/or a website to the storage unit of the control unit 150 for instructions to be executed by the processing unit of the control unit 150. The processing unit of the control unit 150 executing the software application may receive the data from the at least one sensor 140 to determine whether the data is based on based on the television, the movie screen, the movie theater, the play, the concert, and/or the video. Subsequently, the processing unit of the control unit 150 executing the software application may convert at least one image and/or at least one video received through the plurality of lenses 120 from two-dimensional to three-dimensional. In other words, the processing unit of the control unit 150 may render the at least one image and/or the at least one video being viewed as three-dimensional based on light and/or signal emitted from the television, the movie screen, the movie theater, the play, the concert, and/or the video as detected by the at least one sensor 140.

As such, the user may enjoy three-dimensional images and/or videos at any time.

It is important to note that the at least one sensor 140 may send the data to the control unit 150 in response to viewing the television, the movie screen, the movie theater, the play, the concert, and/or the video. As such, the control unit 150 may distinguish viewing any other object and/or an environment, such that the control unit 150 may abstain from converting the at least one image and/or the at least one video received through the plurality of lenses 120 from two-dimensional to three-dimensional where the object being viewed is not the television, the movie screen, the movie theater, the play, the concert, and/or the video.

Furthermore, the control unit 150 may turn on the plurality of lights 130 in response to the at least one sensor 140 detecting dark and/or low light conditions. Also, the control unit 150 may use light from the plurality of lights 130 to convert the at least one image and/or the at least one video viewed on the plurality of lenses 120 from two-dimensional to three-dimensional. As such, the control unit 150 may convert the at least one image and/or the at least one video received through the plurality of lenses 120 from two-dimensional to three-dimensional in bright conditions only.

The power source 160 may include a solar cell and a battery, but is not limited thereto.

The power source 160 may be disposed on at least a portion of each of the plurality of temples 112. The power source 160 may provide power to the plurality of lenses 120, the plurality of lights 130, the at least one sensor 140, and/or the control unit 150. The power source 160 may provide power for a predetermined period of time. For example, the power source 160 may provide power from forty-eight (48) to seventy-two (72) hours. However, the power source 160 may provide power for a longer period of time than described herein.

Therefore, the view enhancing eyewear 100 may convert a two-dimensional image to a three-dimensional image to increase a viewing experience of the user. Also, the view enhancing eyewear 100 may distinguish specific types of items to perform the conversion.

The present general inventive concept may include a view enhancing eyewear 100, including a frame 110 to be worn on at least a portion of a face of a user, a plurality of lenses 120 removably connected to at least a portion of the frame 110, at least one sensor 140 disposed within at least a portion of the frame 110 to detect light received thereon and send data therefrom, and a control unit 150 disposed within at least a portion of the frame 110 to convert at least one of at least one image and at least one video viewed on the plurality of lenses 120 from two-dimensional to three-dimensional in response to determining the data from the at least one sensor 140 is from at least one of a television, a movie screen, a movie theater, a play, a concert, and a video.

Each of the plurality of lenses 120 may correct vision of the user.

The control unit 150 may abstain from converting at least one of the at least one image and the at least one video viewed on the plurality of lenses 120 from two-dimensional to three-dimensional in response to determining the data from the at least one sensor 140 is an object other than at least one of the television, the movie screen, the movie theater, the play, the concert, and the video.

The control unit 150 may determine the data from the at least one sensor 140 is from at least one of the television, the movie screen, the movie theater, the play, the concert, and the video based on light received therefrom.

The view enhancing eyewear 100 may further include a plurality of lights 130 disposed on at least a portion of the frame 110 to emit a beam of light to illuminate a surrounding area in response to being turned on.

The control unit 150 may turn on the plurality of lights 130 in response to the at least one sensor 140 detecting at least one of dark and low light conditions and uses light from the plurality of lights 130 to convert at least one of the at least one image and the at least one video viewed on the plurality of lenses 120 from two-dimensional to three-dimensional.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A view enhancing eyewear, comprising:
a frame to be worn on at least a portion of a face of a user;
a plurality of lenses removably connected to at least a portion of the frame;
at least one sensor disposed within at least a portion of the frame to detect light received thereon and send data therefrom; and
a control unit disposed within at least a portion of the frame to convert at least one of at least one image and at least one video viewed on the plurality of lenses from two-dimensional to three-dimensional in response to determining the data from the at least one sensor is from at least one of a television, a movie screen, a movie theater, a play, a concert, and a video.

2. The view enhancing eyewear of claim 1, wherein each of the plurality of lenses corrects vision of the user.

3. The view enhancing eyewear of claim 1, wherein the control unit abstains from converting at least one of the at least one image and the at least one video viewed on the plurality of lenses from two-dimensional to three-dimensional in response to determining the data from the at least one sensor is an object other than at least one of the television, the movie screen, the movie theater, the play, the concert, and the video.

4. The view enhancing eyewear of claim 1, wherein the control unit determines the data from the at least one sensor is from at least one of the television, the movie screen, the movie theater, the play, the concert, and the video based on light received therefrom.

5. The view enhancing eyewear of claim 1, further comprising:
a plurality of lights disposed on at least a portion of the frame to emit a beam of light to illuminate a surrounding area in response to being turned on.

6. The view enhancing eyewear of claim 5, wherein the control unit turns on the plurality of lights in response to the at least one sensor detecting at least one of dark and low light conditions and uses light from the plurality of lights to convert at least one of the at least one image and the at least one video viewed on the plurality of lenses from two-dimensional to three-dimensional.
